(19) United States
(12) Patent Application Publication
(10) Pub. No.: US 2025/0189351 A1
(43) Pub. Date: Jun. 12, 2025

(54) Mower

(71) Applicant: CLAAS Saulgau GmbH, Bad Saulgau (DE)

(72) Inventors: Simon Frye, Bad Saulgau (DE); Fabian Knupfer, Biberach (DE); Sascha Pflanze, Braunenweiler (DE)

(21) Appl. No.: 18/975,650

(22) Filed: Dec. 10, 2024

(30) Foreign Application Priority Data
Dec. 11, 2023 (DE) 102023134642.3

(51) Int. Cl. G01D 21/02; A01D 43/10

(52) U.S. Cl. CPC G01D 21/02; A01D 43/10

(57) ABSTRACT

The invention relates to a mower (1), comprising a plurality of mowing elements positioned next to one another to form a mower bar (2), and comprising a roller conditioner (4), which is arranged behind the mower bar (2), as seen in the material flow direction of mowed crop (3), and which has an upper conditioning roller (5) and a lower conditioning roller (6), wherein a gap(s) between the conditioning rollers (5, 6) through which the crop (3) is transported is variable depending on an amount of the crop (3), and wherein provision is made of means for determining a width of the gap(s) and means for determining a travelling speed (V) or harvesting speed (V) and also a control device (9) configured to calculate a volumetric flow rate of the crop (3) from the width of the gap(s), a width (b) of the conditioning rollers (5, 6) and the travelling speed (V) or the harvesting speed (V). (FIG. 1)

The invention relates to a mower according to the preamble of Patent claim 1.

DE 10 2020 124 992 A1 discloses a mower comprising a plurality of mowing elements positioned next to one another to form a mower bar, and comprising a roller conditioner, which is arranged behind the mower bar, as seen in the material flow direction of mowed crop, and which has an upper conditioning roller and a lower conditioning roller, wherein the lower conditioning roller is rotatable about a lower, positionally fixed axis of rotation, wherein the upper conditioning roller is rotatable about an upper, shiftable axis of rotation in such a way that a gap between the conditioning rollers is variable owing to the upper axis of rotation being shifted relative to the lower axis of rotation.

During the harvesting of grass, alfalfas or similar crops using a mower operated by a tractor as carrier vehicle, information about the amounts of mowed crop is not available until the removing vehicles are weighed.

Taking this as a departure point, the object of the invention is to provide a novel mower.

This object is achieved according to the invention by the characterizing features of Patent claim 1.

A mower according to the invention comprises a plurality of mowing elements positioned next to one another and forming a mower bar, and comprises a roller conditioner, which is arranged behind the mower bar, as seen in the material flow direction of mowed crop, and which has an upper conditioning roller and a lower conditioning roller, between which a gap is formed through which the crop is transported. The width of the gap changes depending on the amount of crop, wherein according to the invention provision is made of means for determining the width of the gap and means for determining the travelling speed or harvesting speed and also a control device configured to calculate a volumetric flow rate of the crop from the width of the gap, a width of the conditioning rollers and the travelling speed or the harvesting speed.

According to one advantageous development, the lower conditioning roller is rotatable about a lower, positionally fixed axis of rotation and the upper conditioning roller, in order to adapt the gap to the amount of crop, is rotatable about an upper, shiftable axis of rotation, such that the upper axis of rotation is shiftable relative to the lower axis of rotation, wherein the upper axis of rotation is arranged pivotably with respect thereto on levers and an angle sensor is provided, which continuously captures the deflection of a lever and communicates the captured measurement signals to the control device.

According to a further advantageous development, the upper conditioning roller is mounted pivotably on a lever at both ends of said roller and an angle sensor is provided on each lever, both of which angle sensors communicate the captured measurement signals to the control device, from which said control device advantageously determines a possible tilting or inclination of the upper conditioning roller and takes it into account in the calculation of the volumetric flow rate of the crop. As a result, a non-uniform distribution of the crop or of the layer thickness of the crop over the width of the conditioning rollers can be captured and the calculated volumetric flow rate of the crop advantageously corresponds more exactly to the amount of crop actually harvested.

According to a further advantageous development, a moisture sensor is provided on the mower, which captures the moisture content of the crop and continuously communicates the changing moisture contents to the control device, from which said control device advantageously determines a dry mass of the harvested crop in conjunction with the volumetric flow rate.

According to a further advantageous development, calibration characteristic curves for calibrating the moisture sensor are stored in the control device, and the control device can calculate a correction of the moisture contents depending on the volumetric flow rate of the crop. As a result, the dry mass is advantageously calculated more exactly.

According to a further advantageous development, the control device receives position data of a Global Positioning System (GPS) and combines them with the respective current volumetric flow rate or the dry mass of the crop and thus advantageously creates a yield mapping, which reveals what amount of crop was mowed or harvested at what position.

From the location-related yield data emerging therefrom, operating parameters of the following agricultural machines in the harvesting chain can be adapted to the requirements at an early stage. By way of example, when a position with lower yield is approached, fuel can be saved by a targeted reduction of the engine power. It is also advantageously possible to adapt the settings of mounted implements on tractors to the yield amounts in a timely manner. On the basis of the moisture contents, which can likewise be recorded in the yield map, it is advantageously possible for example to generate indications for following agricultural machines that warn about water holes, for example.

Furthermore, the location-related yield data can be used to satisfy the legal requirements for documentation when spreading fertilizer. Moreover, on the basis of the yield map, it is possible to spread fertilizer in a more targeted manner, as a result of which fertilizer can advantageously be saved.

Preferred developments of the invention are evident from the dependent claims and the description. The features of the present invention are explained in greater detail below on the basis of exemplary embodiments, without being restricted thereto. In the associated schematic drawings,

FIG. 1 shows a side view of a mower according to the invention with a first amount of crop,

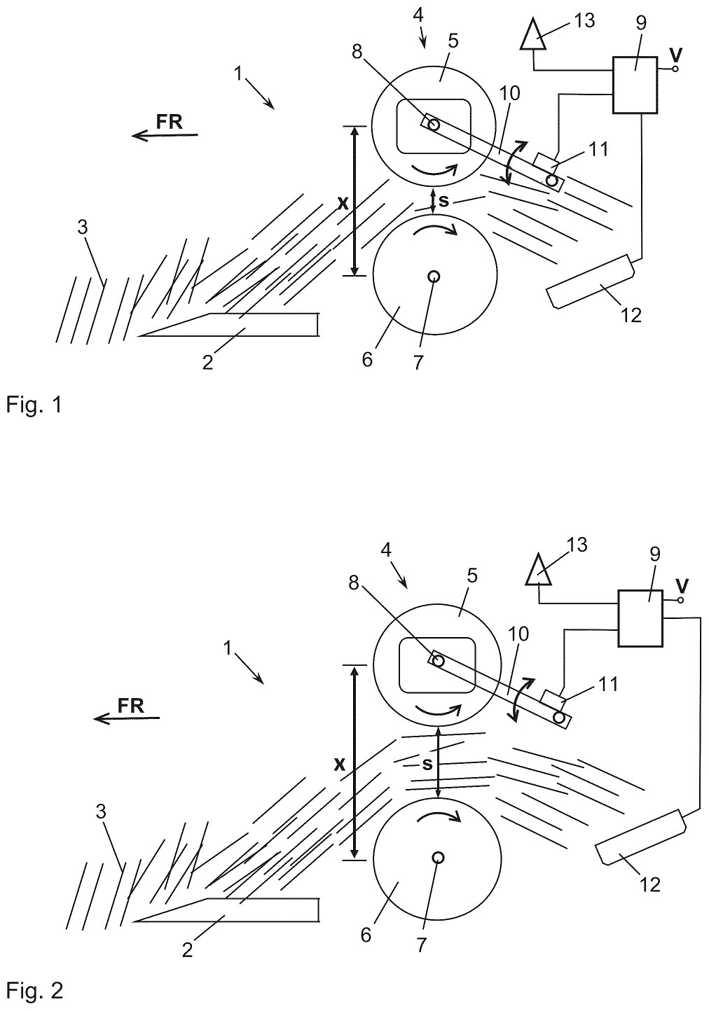

FIG. 2 shows a side view of a mower according to the invention with a larger amount of crop, and

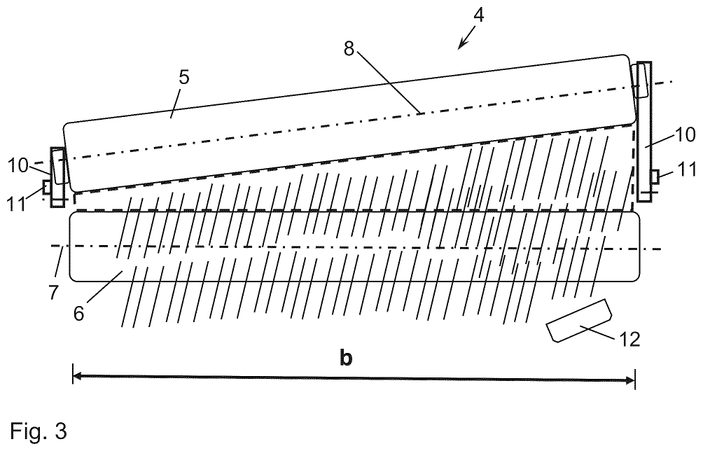

FIG. 3 shows a view of a mower according to the invention in the material flow direction of mowed crop.

FIG. 1 shows a highly schematic side view of a mower 1 according to the invention comprising a mower bar 2, which consists of a plurality of mowing elements positioned next to one another and downstream of which, as seen in the material flow direction of mowed crop 3, there is disposed a roller conditioner 4. The roller conditioner 4 comprises an upper conditioning roller 5 and a lower conditioning roller 6, between which a gap s is formed and between which the crop 3 is transported through. The upper conditioning roller 5 rotates in the anticlockwise direction about an axis of rotation 8 and the lower conditioning roller 6 rotates in the clockwise direction about a lower axis of rotation 7, wherein the gap s changes depending on an amount of the crop 3 which is transported through or conveyed through between the conditioning rollers 5, 6.

The lower axis of rotation 7 of the lower conditioning roller 6 is arranged in a positionally fixed manner and the upper axis of rotation 8 of the upper conditioning roller 5 is arranged so as to be shiftable in order to adapt the gap s to the amount of crop 3, with the result that the distance x between the axes of rotation 7, 8 and the width of the gap s can change. For this purpose, the upper axis of rotation 8 is arranged pivotably on levers 10 and an angle sensor 11 is provided on one of the levers 10, which angle sensor continuously captures the deflection of the lever 10 and communicates the captured measurement signals to a control device 9.

In order to determine the width of the gap s, alternatively or additionally other sensors can be provided, such as optical sensors or cable pull sensors, for example.

The mower 1 is taken up, driven and moved in the travel direction FR for the harvesting process by a carrier vehicle, such as a tractor, in a generally known manner. Via a data connection, preferably a so-called ISOBUS, the travelling speed V or harvesting speed V attained in this case can be continuously transferred from the tractor and fed to the control device 9. Alternatively, in order to capture the travelling speed V or harvesting speed V, a corresponding sensor system that continuously communicates said speed to the control device 9 can be provided on the mower 1.

The control device 9 is configured such that, from the measurement values from the angle sensor 11 that are communicated to the control device, and from the geometry data of the lever 10 that are stored in the control device, the control device continuously calculates the width of the gap s and, by way of the width b of the conditioning rollers 5, 6, said width likewise being stored in the control device, determines a passage cross-section of the crop 3. Furthermore, the control device 9 is configured to compute the passage cross-section between the conditioning rollers 5, 6 with the current travelling speed V or harvesting speed V, in order to calculate a volumetric flow rate of the crop 3, representing an approximation for the amount of mowed crop 3.

In the exemplary embodiment illustrated, a moisture sensor 12 is also provided, which captures the moisture content of the mowed crop 3 and continuously communicates the moisture contents to the control device 9. The control device 9 determines therefrom a dry mass of the harvested crop 3 in conjunction with the volumetric flow rate. It is also possible for a plurality of moisture sensors 12 to be arranged in a manner distributed over the width b of the conditioning rollers 5, 6, in order to capture the moisture content at various points of the material flow.

Preferably, calibration characteristic curves for calibrating the moisture sensor 12 or the plurality of moisture sensors 12 are stored in the control device 9, whereby the control device 9 calculates a correction of the moisture contents depending on the volumetric flow rate of the crop 3 and takes it into account in the calculation of the dry mass of the crop 3.

If moisture sensors 12 having a capacitive action are used, it is important to arrange them at a point of the material flow where the crop 3 has a constant layer thickness.

Alternatively or additionally, near infrared sensors (NIR sensors) can be provided for measuring the moisture content. It goes without saying that it is also possible to provide other sensor systems that are suitable for determining the moisture content of crop.

Furthermore, the control device 9 is configured to receive position data of a GPS system 13 for determining the current position of the mower 1, to combine them with the determined current volumetric flow rate or the determined current dry mass of the crop 3 and thus to create a yield mapping. How much dry mass of crop 3 has been mowed or harvested at what position can be inferred from the yield map created. Likewise, the volumetric flow rate depending on the position could alternatively be read out.

The control device 9 can provide the yield map and/or further data from among those determined to a superordinate data system that can be accessed by other machines involved in the harvesting chain. From the location-related data of the yield map, operating parameters of the following agricultural machines in the harvesting chain can be adapted to the requirements at an early stage. By way of example, when a position with lower yield is approached, fuel can be saved by a targeted reduction of the engine power. When a position or an area with a higher yield amount is approached, on the other hand, the engine power can be adapted to the higher demand in a timely manner. As a result, delays in the harvesting chain can advantageously be avoided.

In the yield map, the moisture values can additionally be recorded, from which indications for following agricultural machines can be generated, in order to warn about water holes for example at particularly moist positions.

FIG. 2 shows a further highly schematic side view of a mower 1 according to the invention with a larger amount of crop 3 by comparison with the view in FIG. 1. It is clear that the distance x between the axes of rotation 7, 8 and the gap s between the conditioning rollers 5, 6 are significantly larger than in FIG. 1. That is to say that this side view of the mower 1 illustrates how a larger amount of crop 3 is mowed and processed between the conditioning rollers 5, 6, in particular conditioned for faster drying.

FIG. 3 shows a view in the flow direction of the mowed crop 3. In this case, it is evident that the upper conditioning roller 5 is mounted in each case pivotably on a lever 10 at both ends or end faces of said roller in order to adapt the distance x or the gap s to different amounts of crop 3. In this case, an angle sensor 11 is preferably provided on each lever 10, which angle sensors communicate the captured measurement signals to the control device 9. From the two measurement signals, the control device 9 determines a possible tilting or inclination of the upper conditioning roller 5 (such as is illustrated by way of example in FIG. 3) and continuously calculates therefrom a passage cross-section (depicted as a dashed line in FIG. 3) which corresponds to the inclination or tilting and through which the crop 3 is conveyed. This passage cross-section is used for calculating the volumetric flow rate of the crop (3).

In the preceding description, the mower 1 has been illustrated very highly schematically and moreover only the component parts that are relevant to the present invention have been described. It goes without saying that a mower 1 according to the invention also has all further generally customary component parts that are sufficiently known to a person skilled in the art.

### List of Reference Signs

1 Mower
2 Mower bar
3 Crop
4 Roller conditioner
5 Conditioning roller
6 Conditioning roller
7 Axis of rotation
8 Axis of rotation
9 Control device
10 Lever
11 Angle sensor
12 Moisture sensor
13 GPS system
X Distance
S Gap
b Width
FR Travel direction/Harvesting direction
V Travelling speed/Harvesting speed

1. A mower (1), comprising a plurality of mowing elements positioned next to one another to form a mower bar (2), and comprising a roller conditioner (4), which is arranged behind the mower bar (2), as seen in the material flow direction of mowed crop (3), and which has an upper conditioning roller (5) and a lower conditioning roller (6), wherein a gap(s) between the conditioning rollers (5, 6) through which the crop (3) is transported is variable depending on an amount of the crop (3), characterized by means for determining a width of the gap (s) and means for determining a travelling speed (V) or harvesting speed (V) and also a control device (9) configured to calculate a volumetric flow rate of the crop (3) from the width of the gap(s), a width (b) of the conditioning rollers (5, 6) and the travelling speed (V) or the harvesting speed (V).

2. The mower (1) according to claim 1, characterized in that the lower conditioning roller (6) is rotatable about a lower, positionally fixed axis of rotation (7) and the upper conditioning roller (5), in order to adapt the gap(s) to the amount of crop (3), is rotatable about an upper, shiftable axis of rotation (8), such that the upper axis of rotation (8) is shiftable relative to the lower axis of rotation (7), wherein the upper axis of rotation (8) is arranged pivotably with respect thereto on levers (10) and an angle sensor (11) is provided, which continuously captures the deflection of a lever (10) and communicates the captured measurement signals to the control device (9).

3. The mower (1) according to claim 2, characterized in that the upper conditioning roller (5) is mounted pivotably on a lever (10) at both ends of said roller and an angle sensor (11) is provided on each lever (10), both of which angle sensors communicate the captured measurement signals to the control device (9), from which said control device determines a possible tilting or inclination of the upper conditioning roller (5) and takes it into account in the calculation of the volumetric flow rate of the crop (3).

4. The mower (1) according to claim 1, characterized in that a moisture sensor (12) is provided, which captures the moisture content of the crop (3) and continuously communicates the moisture contents to the control device (9), from which said control device determines a dry mass of the harvested crop (3) in conjunction with the volumetric flow rate.

5. The mower (1) according to claim 4, characterized in that calibration characteristic curves for calibrating the moisture sensor (12) are stored in the control device (9), and the control device (9) calculates a correction of the moisture contents depending on the volumetric flow rate of the crop (3).

6. The mower (1) according to claim 1, characterized in that the control device (9) receives position data of a GPS system (13) and combines them with the current volumetric flow rate or a dry mass of the crop (3) and thus creates a yield map.
